(19) United States
(12) Patent Application Publication
(10) Pub. No.: US 2024/0429852 A1
(43) Pub. Date: Dec. 26, 2024

(54) TRUSS ADAPTERS AND TRUSS BEARING ADAPTERS FOR TERRAIN FOLLOWING SINGLE-AXIS TRACKERS

(71) Applicant: Ojjo, Inc., San Rafael, CA (US)

(72) Inventor: Greg McPheeters, Santa Cruz, CA (US)

(73) Assignee: Ojjo, Inc., San Rafael, CA (US)

(21) Appl. No.: 18/748,888

(22) Filed: Jun. 20, 2024

Related U.S. Application Data
(60) Provisional application No. 63/522,056, filed on Jun. 20, 2023.

(51) Int. Cl. H02S 20/10

(52) U.S. Cl. CPC H02S 20/10

(57) ABSTRACT

A combined truss adapter and bearing for a single-axis tracker. The truss adapter has a pair of connecting portions joined together by a bridge. A pair of parallel flanges on the bridge extend upward and away from bridge to support flanges of a bearing assembly. Bolts passing through the flanges and bearing assembly enable the bearing assembly to be rotated with respect to the bridge portion.

### CROSS REFERENCE TO RELATED APPLICATIONS

This application claims priority to U.S. provisional application No. 63/522,056 filed on Jun. 20, 2023, titled “TRUSS ADAPTERS AND TRUSS BEARING ADAPTERS FOR TERRAIN FOLLOWING SINGLE-AXIS TRACKERS” the disclosure of which is hereby incorporated by reference in its entirety.

### BACKGROUND

Utility-scale solar development in the United States and other parts of the world relies largely on single-axis solar trackers. Single-axis solar trackers consist of North-South oriented rows of solar panels attached to a torque tube or other structure that is turned slowing to change the panels from an East-facing orientation to a West-facing orientation each day as the sun moves westwardly through the sky.

In the early days of utility-scale solar development when solar panels were still relatively expensive on a per watt basis, only the flattest sites would be chosen to develop for large scale power plants. However, as the price of solar panels dropped and flat land became scarcer, projects were developed on land with some degree of contour. Typically, this required grading of the construction site to essentially planarize the surface on which to construct the array. Lately, for environmental reasons, cost saving reasons, and in some cases due to restrictive covenants on certain government or BLM owned land, grading has fallen out of favor. As a result, leading tracker makers such NEXTracker Inc., of Freemont, CA, Array Technologies Inc., of Albuquerque, NM, and Game Change Solar, of Norwalk, CT, among others, are all bringing to market single-axis tracker systems that allow the torque tube to flex and essentially follow the up and down contours of the terrain along the North-South oriented rows within certain limits. Since these companies don't typically incorporate their own foundations into their products, this creates some challenges for project developers and foundation suppliers to provide solutions that can handle the different load profiles and accept the angular variances of a terrain following trackers.

To that end, the applicant of this application has developed various truss adapters for its proprietary EARTH TRUSS foundation system that will support terrain following single-axis tracker by providing adjustability, in particular, in pitch and yaw, as these values may change from foundation point to foundation point and would otherwise require a degree of unique precision for each foundation point that would be difficult to achieve.

### BRIEF DESCRIPTION OF THE DRAWINGS

FIG. 1A is an EARTH TRUSS foundation system with a single-axis tracker bearing assembly;

FIG. 1B is a perspective view of the tracker bearing assembly and truss adapter of FIG. 1A;

FIG. 2A is a perspective view of a tracker bearing assembly and truss adapter according to at least one exemplary embodiment;

FIG. 2B is an exploded view of the tracker bearing assembly and truss adapter of FIG. 2A;

FIG. 3A is a perspective of a tracker bearing assembly and another truss adapter according to at least one exemplary embodiment;

FIG. 3B is an exploded view of the tracker bearing assembly and truss adapter of FIG. 3A;

FIG. 3C is a bottom perspective view of the truss adapter of FIG. 3A;

FIG. 4A is a perspective of a tracker bearing assembly and yet another truss adapter according to at least one exemplary embodiment;

FIG. 4B is an exploded view of the tracker bearing assembly and truss adapter of FIG. 4A;

FIG. 4C is a bottom perspective view of the truss adapter of FIG. 4A;

FIG. 5A is a perspective of a tracker bearing assembly and a further truss adapter according to at least one exemplary embodiment;

FIG. 5B is a front view of the tracker bearing assembly and truss adapter of FIG. 5A;

FIG. 5C is a side view of the tracker bearing assembly and truss adapter of FIG. 5A;

FIG. 5D is an exploded view of the tracker bearing assembly and truss adapter of FIG. 5A;

FIG. 6A is a perspective of a tracker bearing assembly and an additional truss adapter according to at least one exemplary embodiment;

FIG. 6B is an exploded view of the tracker bearing assembly and truss adapter of FIG. 6A;

FIG. 7A is a perspective of a tracker bearing assembly and a further truss adapter according to at least one exemplary embodiment;

FIG. 7B is an exploded view of the tracker bearing assembly and truss adapter of FIG. 7A;

FIG. 8A is a perspective of an integrated spherical tracker bearing assembly and truss adapter according to at least one exemplary embodiment;

FIG. 8B is a side view of the integrated spherical tracker bearing assembly and truss adapter of FIG. 8A;

FIG. 8C is an exploded view of the integrated spherical tracker bearing assembly and truss adapter of FIG. 8A;

FIG. 9A is a perspective of another integrated spherical tracker bearing assembly and truss adapter according to at least one exemplary embodiment; and

FIG. 9B is an exploded view of the integrated spherical tracker bearing assembly and truss adapter of FIG. 9A.

### DETAILED DESCRIPTION

The following description is intended to convey a thorough understanding of the embodiments described by providing a number of specific embodiments and details involving truss foundations for terrain following single-axis solar trackers. It should be appreciated, however, that the present invention is not limited to these specific embodiments and details, which are exemplary only. It is further understood that one possessing ordinary skill in the art in light of known systems and methods, would appreciate the use of the invention for its intended purposes and benefits in any number of alternative embodiments, depending upon specific design and other needs.

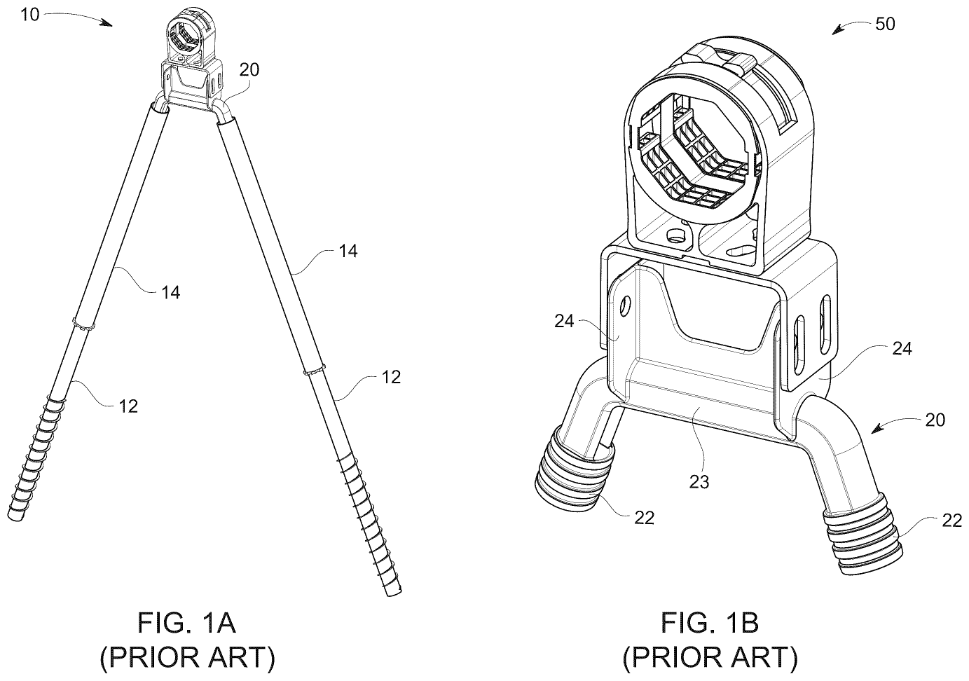

Turning now to the drawing figures, FIGS. 1A and 1B show an exemplary EARTH TRUSS single-axis solar tracker foundation manufactured and sold by the applicant Ojjo, Inc. of San Rafael, CA. As shown in exemplary FIGS. 1A and B, EARTH TRUSS foundation 10 consists of a pair of screw anchors 12 that are driven partially into the ground, a pair of upper legs 14 axially extending the screw anchors, and a so-called truss cap or truss adapter 20. Truss adapter 20 unifies the foundation legs and provides a platform on which to attach single-axis tracker components such as tracker bearing assembly 50. In the example of FIG. 1, bearing assembly 50 is a bearing assembly from Array Technologies, Inc., however, it should be appreciated that EARTH TRUSS foundation 10 is capable of supporting trackers from several different manufacturers. Bearing 50 is shown for exemplary purposes only to illustrate how the EARTH TRUSS foundation supports a single-axis tracker. It should be appreciated that most tracker makers make bearing components that are dimensioned to fit on the top end of a standard I-beam known in the utility scale solar field as H-piles. Truss adapter 20 dimensionally mimics the web and flange geometry of the conventional H-pile.

Exemplary truss adapter 20 shown in FIGS. 1A and B includes a pair of connecting portions 22 that are received in respective ones of upper legs 14. Connecting portions 22 are slightly oblate and have a series of channels formed in them that circumscribe their outer surface. When assembling the EARTH TRUSS, a hydraulic crimper is used to deform the upper leg tube into the channels formed in connecting portions 22 to ensure a strong connection. The teeth of the crimper are perfectly aligned with the channels so that maximum deformation of the upper leg tube 14 may occur thereby ensuring a secure crimp fit. Bridge portion 23 of adapter 20 includes a pair of vertical flanges 24 that approximate the geometry of a conventional I-beam (wide flange 6″×9″ beam known in the utility scale solar arts as an H-pile) that has traditionally been used to support bearing assemblies like bearing assembly 50. Bearing assembly 50 also has a pair of flanges that fit over flanges 24 with slots in flanges 24. These slots provide some degree of Z-axis and pitch adjustment. When supported by I-beams, the beams would come with holes pre-drilled to mate with bearing assembly 50.

Tracker makers typically specify tight tolerances for the foundations supporting their trackers. That means that the foundation needs to be in the right place along the row (X direction), at the right height (Z direction), on the row as opposed to East or West of it (Y direction) and needs to be at the right pitch and roll (e.g., plumb), and at the right yaw (aligned with the X axis with the flanges facing East-West). In the case of the EARTH TRUSS foundation, most of this is achieved with precise placement of the machine and correct orientation of the mast to drive the screw anchors along respective drive axes that intersect at the desired work point of the truss. This ensures that when tracker bearings are attached, that the rotational axis of the tracker will be within the tolerance specified by the tracker maker. However, due to conditions encountered during driving and inherent error tolerances in GPS, linear encoders and other tools used to orient the machine mast that drives the screw anchors and assembles the truss, it is necessary to build some degree of adjustability into the truss adapter at the point or points where it interfaces with the tracker bearing to enable the bearing to be properly aligned to support the torque tube, that is, to compensate for any misaligned of the truss foundation from its intended position and orientation. Terrain following trackers may require even more adjustability to minimize wear on the tracker components during operation as the torque tube may, in some cases, change pitch between each successive foundation. Unlike conventional trackers where the torque tube is oriented as an essentially straight axis, in a terrain following tracker, the torque tube may bend with the curvature of the underlying land meaning that each foundation may be at a different height, and in the case of the EARTH TRUSS, may have a different work point.

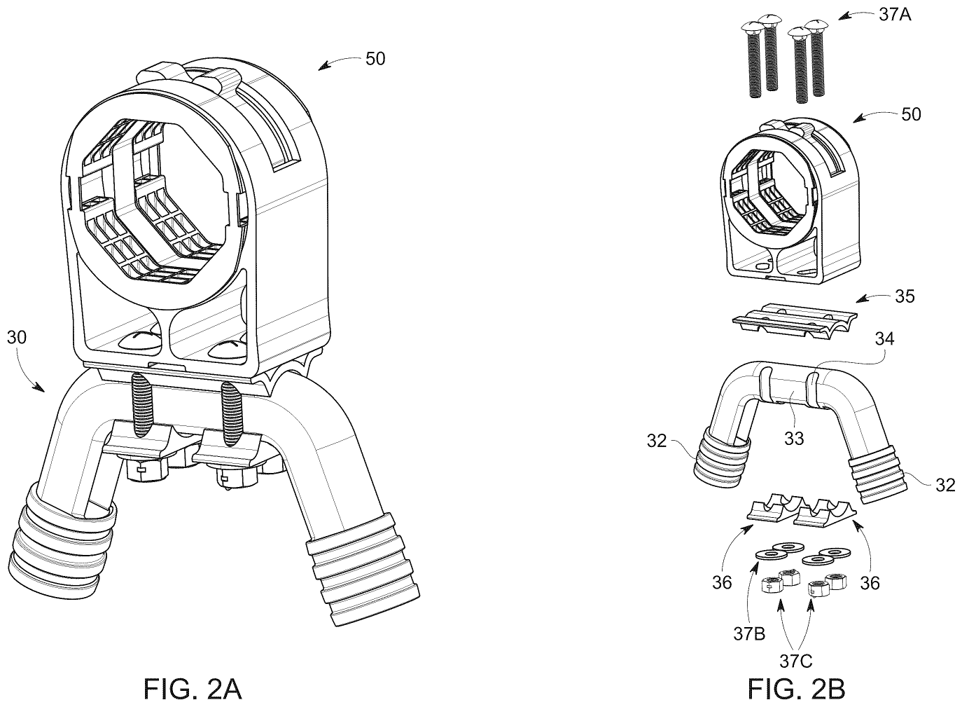

Turning now to FIGS. 2A and B, these figures show single-axis tracker bearing assembly and truss adapter 30 according to various exemplary embodiments. Truss adapter 30 is similar to truss adapter 20 in that it includes a pair of connecting portions 32 that are received in upper leg sections of the truss and are crimped over to secure the legs to the truss adapter. Truss adapter 30 also has bridge portion 33 that provides a support platform for the bearing assembly, in this example, assembly 50. However, unlike adapter 20, adapter 30 has vertical grooves 34 formed in bridge portion 33 that enable bearing assembly 50 to lean forward or backwards (adjust in pitch) to accommodate changes in the underlying terrain. Upper adapter plate 35 sits between bearing assembly 50 and bridge 33 while lower adapter plates 36 match the curved cross-sectional profile of the bridge from below. Bolts 37A pass through the bottom of bearing assembly 50, through upper adapter plate 35, into slots 34, through lower adapter plates 36, and washers 37B, and are retained with nuts 37C. This configuration provides several degrees of pitch adjustability and at least one to two degrees of yaw adjustment. Upper and lower adapter plates 35 and 36 enable bearing adapter 50 and bolts 37C to sit on planer surfaces and bolts 37A to remain perpendicular to those planar surfaces to maximize holding strength at the desired orientation of the bearing assembly 50 relative to the adapter.

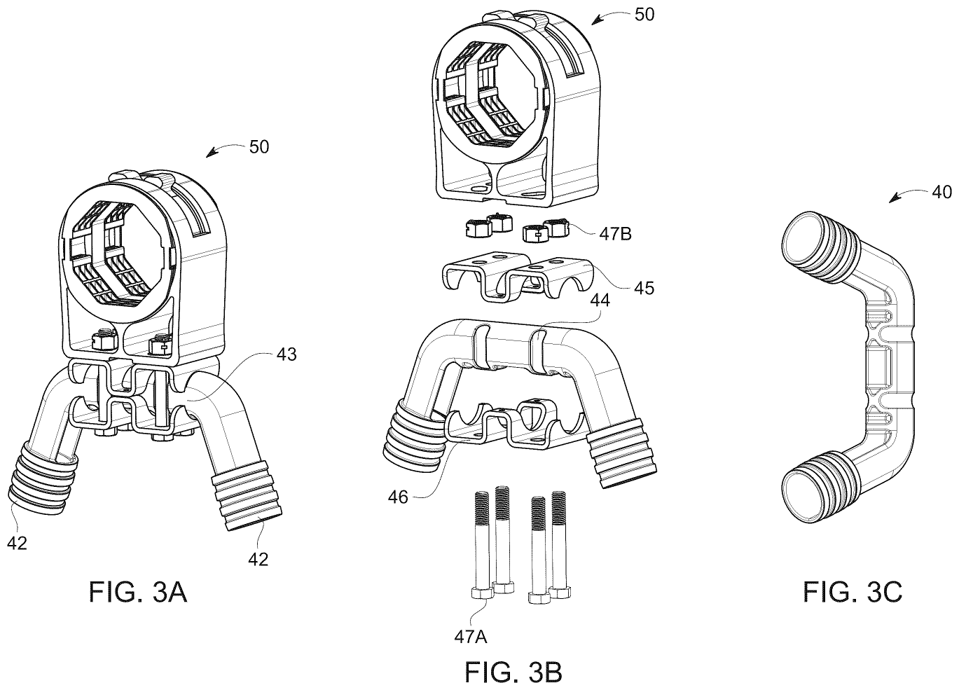

Turning now to FIGS. 3A, 3B, and 3C, these figures show yet another truss adapter 40. Truss adapter 40 is similar to truss adapter 30 with connecting portions 42, bridge portion 43, and two pairs of opposing channels 44 formed in bridge portion 43. Here upper and lower adapter plates 45, 46 have been condensed into a single SKU for ease of manufacturing and assembly. In other words, in various embodiments, they are the same part. Like adapter plates 35, 36, upper adapter plates 45 provide a planar support surface for bearing assembly 50 that is adjustable to various different pitches about the bridge on the upper side while providing a curved surface that matches the cross section of the bridge on the lower side. Bolts 47A pass through each adapter plate 45/46 and into channels 44 before being bolted down with nuts 47B to the bearing assembly. Channels 44 provide several degrees of pitch adjustment with one to two degrees of yaw adjustment.

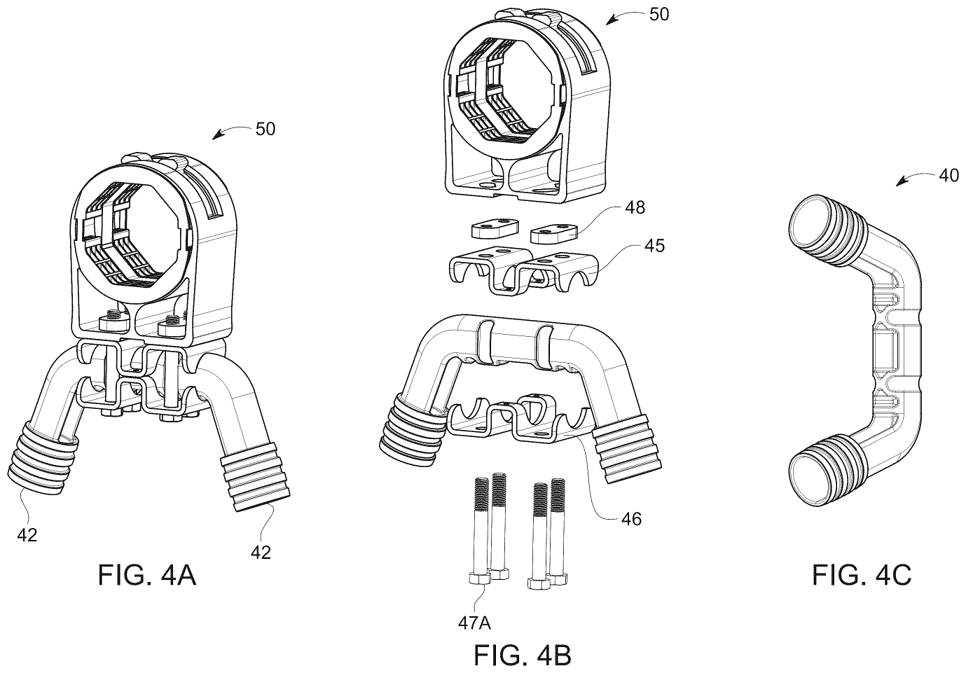

FIGS. 4A-4C show the same truss adapter 40, however, in the exemplary embodiment shown in this figure, nuts 47B have been replaced with threaded compression plates 48. In various embodiments, compression plates 48 have holes that overlap with the spacing of the holes formed in upper and lower adapter plates 45, 46. Compression plates 48 are placed inside bearing assembly 50 on the bottom surface and receive the threaded end of bolts 47A, enabling bolts 47A to be torqued down without needing an additional tool to hold plates 48 in place, as is required with nuts 47B.

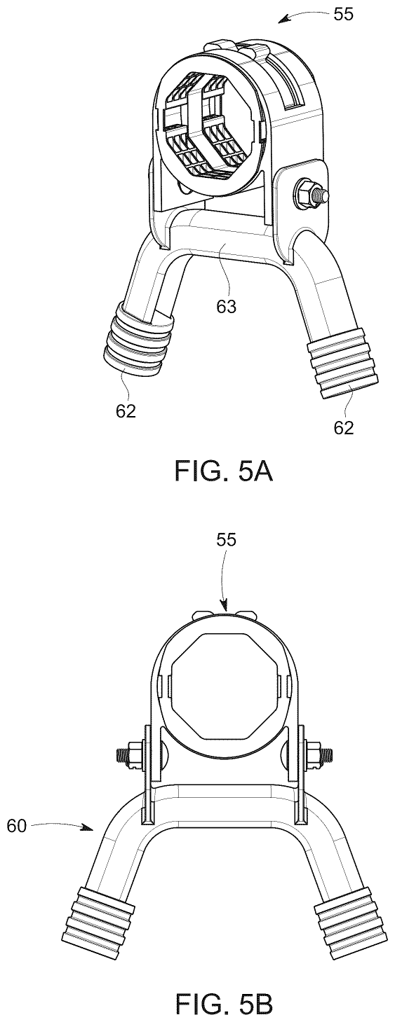

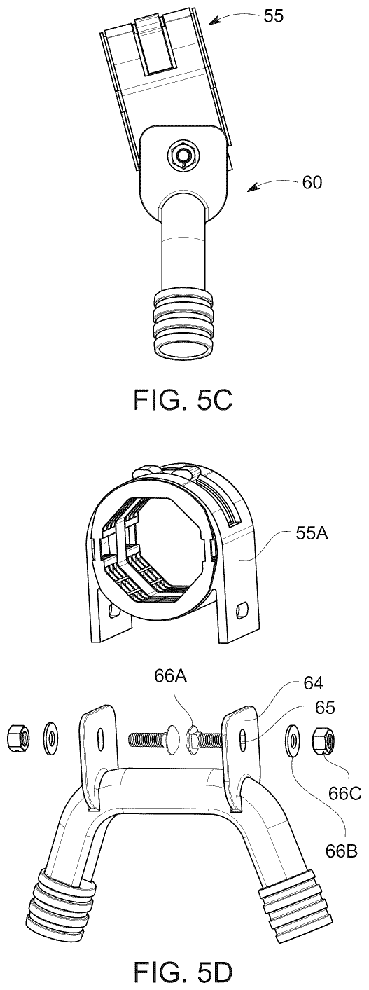

Turning now to FIGS. 5A-D, these figures show yet another truss adapter 60 that provides adjustment with respect to the bearing assembly in height, pitch, and yaw according to various exemplary embodiments. Truss adapter 60 is designed to work with a modified bearing assembly 55. Instead of being fully boxed like bearing assembly 50 shown in the other figures, assembly 55 simply has flanges 55A that fit inside flanges 64 of the adapter. This reduces the amount of steel required to make it. It should be appreciated that flanges 55A may alternatively fit outside flanges 64. Truss adapter 60 has connecting portions 62 and bridge portion 63. It also has parallel flanges 64 projecting upward from the bridge. Pivot bolts 66A pass through flanges 55A, holes 65 in flanges 64 and are secured with washer 66B and nuts 66C. This enables bearing assembly 55 to pivot with respect to adapter 60 to achieve different pitches with respect to adapter 60. The vertically slotted shape of openings 65 also enable some adjustability in height (z), and a small degree (˜1 degree) of yaw adjustment.

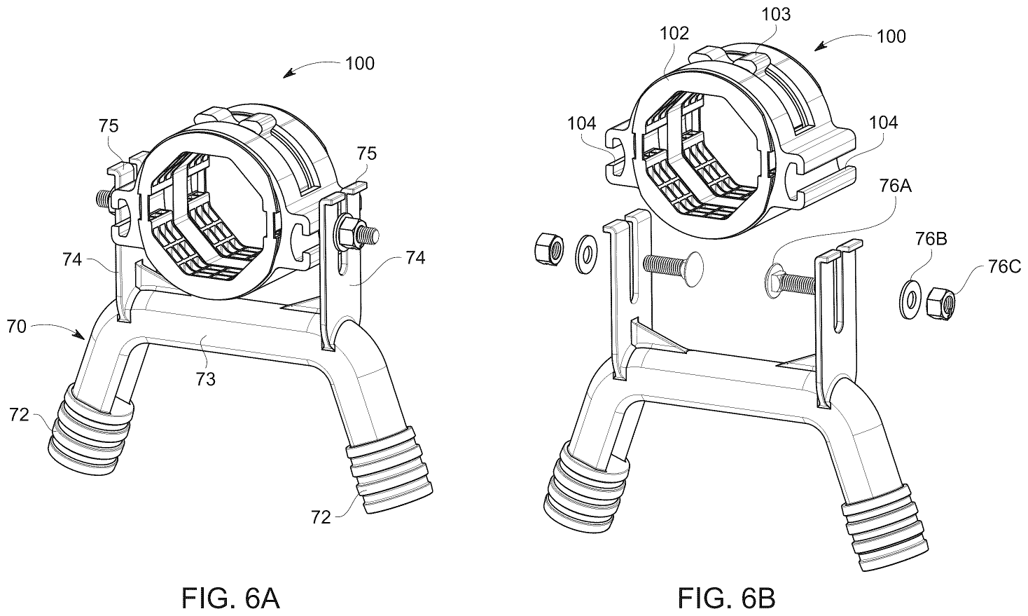

FIGS. 6A and 6B show a truss adapter 70 and modified bearing assembly 100 according to another exemplary embodiment. Truss adapter 70 uses pivot bolts and slots to provide pitch adjustment. This particular embodiment also provides North-South adjustment (x), height adjustment (z), and small amount of yaw adjustment. Like that of previous embodiments, adapter 70 of FIG. 6 has a pair of connecting portions 72, a bridge 73 and a pair of slotted parallel flanges 74 that have opening slots 75 at their distal ends. Slots receive pivot bolts 76A and secure washers 76B, and lock nut 76C to hold novel bearing assembly 100 at the desired orientation. Bearing assembly 100 relies on a standard bushing 102 and lock ring 103, such as that manufactured by ATI and others but with a pair of horizontal slots 104 for receiving the head of pivot bolts 76A. Engagement between slots 104 and pivot bolts 76A allows the bearing 100 to be moved to different positions along the X-axis and to rotate to different pitches. Some small degree of yaw adjustment is also possible.

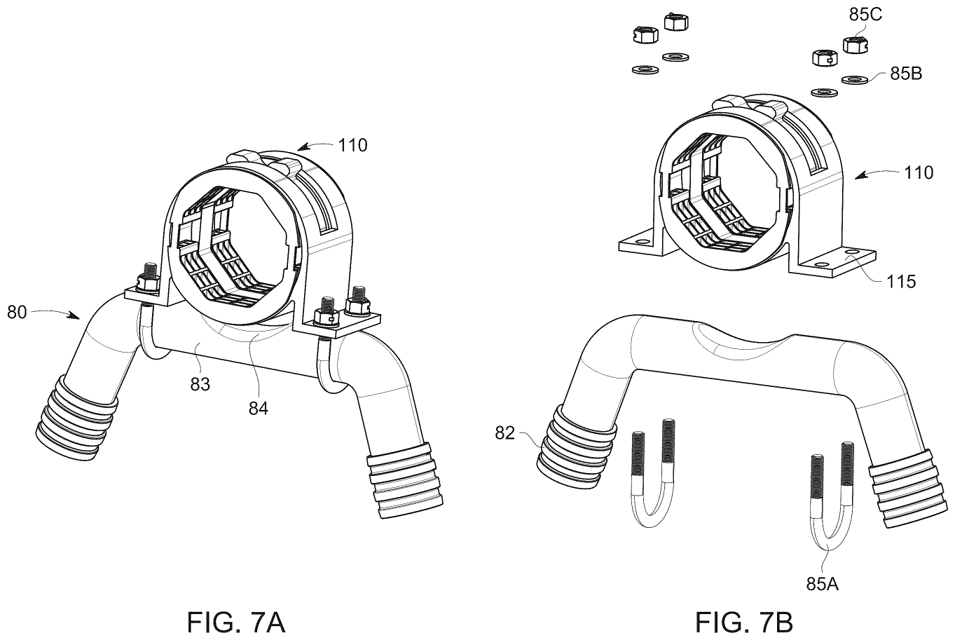

Turning to FIGS. 7A and 7B, these figures show yet another adjustable truss adapter 80 and modified bearing assembly 110 according to various exemplary embodiments. Truss adapter 80 has a pair of connecting portions 82 joined by bridge portion 83. Bridge portion 83 has notch 84 formed in it to accommodate the rounded shape of novel bearing assembly 110. Bearing assembly 110 as shown relies on the standard ATI bushing with a simplified housing having a pair of horizontal flanges 115 that rest on bridge portion 83 rather than the fully boxed version shown in FIGS. 1A and 1B. Flanges 115 have holes that receive U bolts 85A that secure assembly 110 to adapter 80 with washers 85B and nuts 85C. This enables bearing assembly 110 to rotate to different orientations with respect to adapter 80 to adjust in pitch, and to a lesser extent, in yaw.

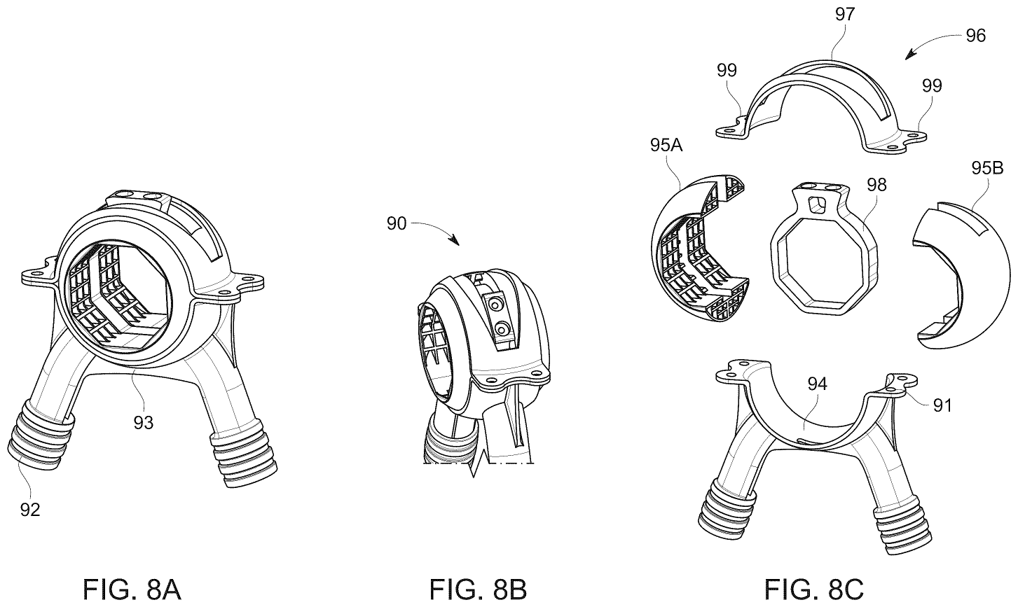

In some cases, it may be desirable to integrate the tracker bearing with the truss cap or truss adapter to an even greater degree than that shown in previous illustrated embodiments. This may reduce part count, total system cost, and speed up the tracker installation process. To that end, various embodiments of the invention achieve this with an integrated truss cap/bearing or bearing adapter such as adapter 90 shown in FIG. 8 in accordance with at least one exemplary embodiment. So called bearing adapter 90 of FIG. 8, due to the inclusion of an integrated bearing in the truss adapter, has a pair of connecting portions 92, bridge portion 93, and a lower semi-spherical concave bearing portion 94. Lower bearing portion 94 has a generally concave spheroid shape that enables it to receive bushing portions 95A/B so that they are fully supported and able to rotate within lower bearing portion 94 with the movement of the tracker torque tube. Lock ring 98 surrounds the torque tube and sits within bushings 95A/B. Upper bearing portion 96 attaches to lower bearing portion 94 via flanges 99 that sit on corresponding flanges 91. Bolts or other fasteners not shown in FIG. 8 are used to secure the two bearing portions together to capture bushings 95A/B, lock ring 98 and the torque tube so that it can rotate but within limits set by opening 97 in upper bearing portion 96. Lobes or stops on lock ring 98 are captured by the dimensions of opening 97 to limit the extent of rotation. Bearing adapter 90 enables the torque tube to rotate to track the sun while being adjustable in pitch and yaw. Due to the 8-sided opening formed in the center of bushings 95A/B, this particular embodiment may be particularly suited for a single-axis tracker with an 8-facted torque tube such as that available from Array Technologies. However, it should be appreciated that other geometries may be possible too. In the Array tracker, stops formed in lock ring are used to limit the extent of rotation of the torque tube. Other trackers use different mechanisms to limit unintended rotation from wind, snow loading and other phenomena.

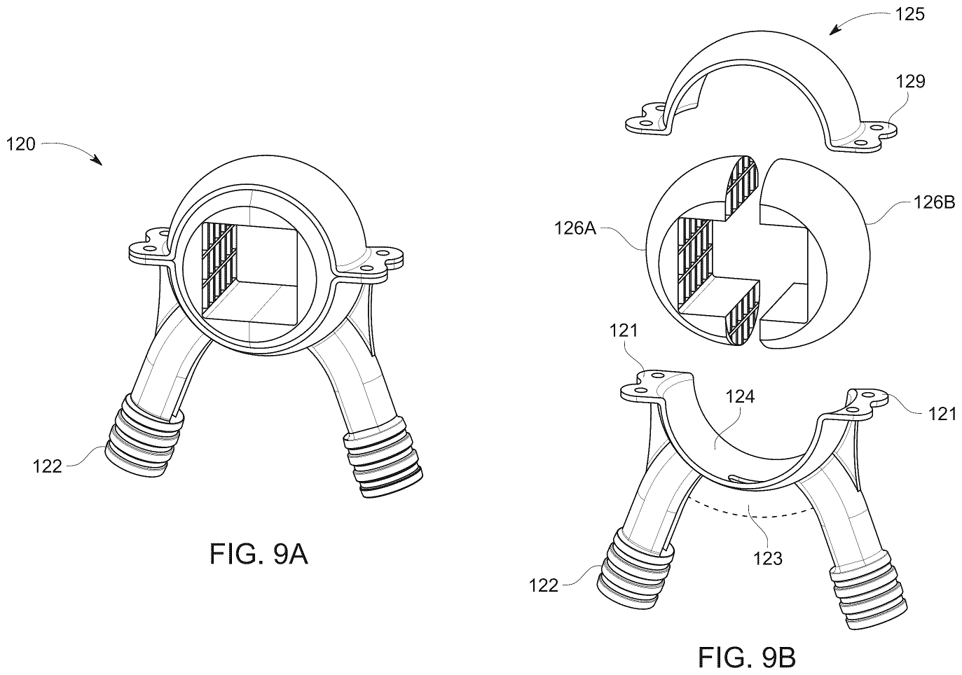

Turning now to FIG. 9, this figure shows truss bearing adapter 120, according to various other embodiments. Bearing adapter 120 is similar to bearing adapter 90, but in accordance with various other embodiments, is designed to work with a single-axis tracker that has a square profile torque tube that doesn't rely on lock rings. For example, GameChange Solar of Norwalk, CN manufactures and sells a single-axis tracker that has a square profile torque tube. Truss bearing adapter 120 has connecting portions 122, bridge portion 123, lower concave bearing portion 124, upper bearing portion 125, and bushings 126A/B. In various embodiments, bushings 126A/B fit together to form a square opening to receive a square profile torque tube and sit in the bearing opening formed when upper bearing portion 125 sits on lower bearing portion 124. Overlapping flanges 121/129 provide through holes for passing bolts, rivets or other fasteners to lock these components together to securely hold the bushing 126A/B and torque tube within the bearing. The spherical shape of the bearing and bushings allow the torque tube to rotate at orientations other than normal (i.e., adjusted in pitch and yaw) to the bearing opening to accommodate pitch and yaw changes incurred as a result of following the terrain.

The embodiments of the present inventions are not to be limited in scope by the specific embodiments described herein. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. An assembly for a truss foundation comprising:
a truss adapter having a pair of connecting portions, a bridge portion, and a first pair of parallel flanges extending above the bridge portion;
a bearing assembly forming a bearing and having a bushing rotatably supported therein, and a second pair of parallel flanges extending from an outer surface of the bearing; and
a pair of pivot bolts passing through the respective ones of the first and second pairs of flanges to enable the bearing assembly to pivot with respect to the truss adapter.

2. The assembly according to claim 1, wherein the bearing assembly further comprises a pair of rotational stops that limit an extent of rotation of the bushing within the bearing.

3. An assembly for a truss foundation comprising:
a truss adapter having a pair of connecting portions, a bridge portion, and concave recess at an approximate center of the bridge portion;
a bearing assembly forming a bearing and having a bushing rotatably supported therein, and a pair of parallel flanges extending away from the bearing; and
a pair of U bolts extending around the bridge portion and through the pair of pair of parallel flanges to secure the bearing assembly to the bridge portion.

4. The assembly according to claim 3, wherein the bearing assembly further comprises a pair of rotational stops that limit an extent of rotation of the bushing within the bearing.

5. The assembly according to claim 3, wherein a curved surface of the bearing fits in the concave recess.

6. A truss bearing adapter for a terrain following single-axis tracker comprising:
a first portion having a pair of connecting portions angled apart from one another, and a first concave spheroid bearing section;
a second portion having a second concave spheroid bearing section, the first portion attaching to the second portion to define a spheroid bearing opening;
a spherical bushing comprising a pair of spherically-shaped halves that sit in the spheroid bearing opening, the bushing having a central passage matching a cross sectional shape of a tracker torque tube and enabling the torque tube to pass through the spheroid bearing opening at a plurality of different angles relative to perpendicular to the spheroid bearing opening while retaining the ability to rotate within the spheroid bearing opening.

7. The truss adapter according to claim 6, further comprising a lock ring surrounding the torque tube and fitting within the bushing.

8. The truss adapter according to claim 7, wherein the lock ring comprises a pair of stops that engage the second portion to limit an extent of torque tube rotation in both clockwise and counterclockwise directions.
